(19) United States
(12) Patent Application Publication
(10) Pub. No.: US 2017/0347152 A1
(43) Pub. Date: Nov. 30, 2017

(54) Systems and Methods for Using Content Protection Signaling to Collect Audience Measurement Data

(71) Applicant: Verimatrix, Inc., San Diego, CA (US)

(72) Inventors: Eric Yam, San Diego, CA (US); Niels J. Thorwirth, San Diego, CA (US); Petr Peterka, San Diego, CA (US)

(73) Assignee: Verimatrix, Inc., San Diego, CA (US)

(21) Appl. No.: 15/534,418

(22) PCT Filed: Dec. 31, 2014
(86) PCT No.: PCT/US14/73078

§ 371 Date: Jun. 8, 2017

(51) Int. Cl. H04N 21/442; H04N 21/4623; H04N 21/266; H04N 21/4405; H04N 21/8547; H04N 21/658

(52) U.S. Cl. CPC H04N 21/44222; H04N 21/8547; H04N 21/6582; H04N 21/26606; H04N 21/44204; H04N 21/4405; H04N 21/4623

(57) ABSTRACT

Systems and methods for collecting audience measurement data using content protection signaling messages while playing back content are disclosed. One embodiment includes receiving content, where content is encrypted using at least one encryption key, receiving a content protection signaling message, where the content protection signaling message is associated with the content and includes a reference timestamp and decryption information associated with the content, processing the content protection signaling message to extract the reference timestamp and the decryption information and generating a message processing timestamp based on the time the content protection signaling message is processed, collecting audience measurement data and saving the audience measurement data into memory, where the audience measurement data includes the reference timestamp and message processing timestamp, recovering at least one decryption key using the decryption information, and decrypting the content using the at least one decryption key.

### FIELD OF THE INVENTION

The present invention relates generally to streaming content in a content playback system with managed rights, such as a conditional access system (CAS), and more specifically to utilizing content protection signaling to collect audience measurement data that includes identification of what content is being viewed by users and when it is being watched.

### BACKGROUND OF THE INVENTION

Operators are looking for ways to understand and predict user behavior and preferences in order to create attractive offerings with minimum investment. Big Data collected from user behavior can provide value to operators in areas related to user experience and quality of experience. First, operators can improve user experience by understanding subscriber preferences and proactively recommending content, creating a positive experience that will ultimately lead to increased loyalty and revenues. Second, operators can use Big Data to simplify cross-domain network planning, system performance monitoring and root cause analysis, in order to offer the required quality of experience while minimizing capital expenditures and operating expenditures.

Big Data can be defined as the collection of digital trails left behind when people click on their computer mouse, press a button on their phone or tablet or (in the media world) use the remoter control to e.g. switch channels on their digital TV. Every time an action of this sort takes place, it creates data—and there are huge amounts of such data generated continuously. Many media owners are already doing things with the Big Data they have—Sky TV in the UK, for example, has recruited a panel of 33,000 of its digital satellite subscribers (it has more than 10 million in total) for which it can track minute-by-minute viewing by channel. Nielsen deployed “National Television Panel” that measures video viewing from 7,500 “National People Meter” homes, representing about 20,000 people and 12,000 devices.

There are many ways of audience measurement: One common way is panel-based audience measurement like Sky TV and Nielsen that tracks user's habits by developing and recruiting a panel that is representative of the population of users, and then installing software on the panelists' device for tracking. But the limited size and diversity of a panel can impact accuracy of numbers, in particular for measurement of fragmented content. Data may be volatile from month to month due to the number of panelists in a survey. Panels may not adequately measure all geographically sites and the reporting, may be subject to a bias on what the subjects want to report if the collection method allows to be influenced by the subject or the subject is aware that her behavior is measured and reported to represent a larger group of consumers. Additionally, panels may not track traffic from many of the new mobile devices.

Background of ECMs in a CA System

A Conditional Access System (CAS) is a complex system that provides access to digital broadcast content for authorized individuals and can be implemented as described as follows.

A CAS server consists of head-end equipment that is connected to multiplexing and scrambling system of Transport Streams (TS) and is configured to manage the process of encryption TV program and data, injecting service information and customer management. A typical CAS system is illustrated in FIG. 1. The Conditional Access System (CAS) has the following components for content protection:

A CA Server (Conditional Access Server) contains a Control Word Generator (CWG) that generates CWs (Control Words) which are used by the scrambler to scramble and thereby secure the content. Encryption is used to protect the control word (CW) during transmission to the client receiver. The control word (CW) is encrypted and delivered via an Entitlement Control Message (ECM). Only the authorized subscriber can decrypt the control word (CW). The entitlement or authority to decrypt the CW in the ECM is sent to the receiver in the form of an Entitlement Management Message (EMM).

An SMS server (Subscriber Management System Server) includes subscriber database, subscriber subscription information and provides operational management. This information can be shared with the CA Server to enable entitlement control of subscribed services and content.

An EPG (Electronic Program Guide) is a navigation system to help the user to select the program. It provides Event Info Scheduler (EIS) with all the schedule information.

A Multiplexer/Scrambler provides the scrambling of audio/video streams using a CW control word. The multiplexer (MUX) accepts Program Streams (PS), Entitlement Management Message (EMM), Entitlement Control Message (ECM) and Event Info Scheduler (EIS) information. The multiplexer (MUX) performs time multiplexing of input data and outputs an MPEG-2 transport stream.

The control word (CW) is typically sent to the receiver in encrypted form within an entitlement control message (ECM). The CW is valid for a particular crypto-period (CP), which is typically 10 seconds long. The ECMs are typically repeated (e.g. 10 times per second) so that the STBs are able to quickly start descrambling after changing channels.

### SUMMARY OF THE INVENTION

Systems and methods for collecting audience measurement data using content protection signaling messages while playing back content are disclosed. One embodiment includes receiving a portion of a piece of content using a playback device, where the piece of content is encrypted using at least one encryption key, receiving a content protection signaling message using the playback device, where the content protection signaling message is associated with the portion of the piece of content and includes a reference timestamp and decryption information associated with the portion of the piece of content, processing the content protection signaling message using the playback device to extract the reference timestamp and the decryption information and generating a message processing timestamp based on the time the content protection signaling message is processed, collecting audience measurement data and saving the audience measurement data into memory, where the audience measurement data includes the reference timestamp and message processing timestamp, recovering at least one decryption key using the decryption information, and decrypting the at least a portion of a piece of content using the at least one decryption key.

A further embodiment also includes generating, using a rights management server, the content protection signaling message and associating the content protection signaling message with the portion of the piece of content, generating the reference timestamp using the rights management server, and embedding, using the rights management server, the reference timestamp within the content protection signaling message.

In another embodiment, the reference timestamp indicates the time of encryption of the portion of the piece of content associated with the content protection signaling message.

In a still further embodiment, the content protection signaling message is a modified Entitlement Control Message (ECM) that is multiplexed with the piece of content in a transport stream, the decryption information includes an encrypted control word (CW), and recovering at least one decryption key using the decryption information includes decrypting the encrypted control word (CW).

In still another embodiment, the content protection signaling message is a key delivery message provided in a playlist associated with the piece of content.

A yet further embodiment also includes determining a device identifier associated with the playback device using the playback device and detecting a compromised device using the device identifier.

Yet another embodiment also includes determining a channel change event and the audience measurement data also includes the channel change event.

A further embodiment again also includes collecting device information from the playback device, where device information includes information from the group of memory usage, network usage, error status, error event, device type, performance change event, and key delivery delay.

Another embodiment again also includes determining a trick play event based upon at least the reference timestamp and a message processing time.

A further additional embodiment also includes receiving a second content protection signaling message using the playback device, where the second content protection signaling message is associated with the portion of the piece of content and includes a second reference timestamp, processing the second content protection signaling message using the playback device to extract the second reference timestamp and generating a second message processing timestamp based on the time the second content protection signaling message is processed, and determining a trick play speed using the reference timestamp, the second reference timestamp, the message processing time, and the second message processing time.

Another additional embodiment also includes determining a content identifier that identifies the piece of content using the playback device, and obtaining a device identifier that identifies the playback device using the playback device, where the audience measurement data also includes the content identifier and the device identifier.

Still yet further embodiment also includes obtaining at least one encryption key from the rights management server using the playback device, sending the audience measurement data to an audience measurement server securely using the playback device and the at least one key obtained from the rights management server.

In still yet another embodiment the content protection signaling message also includes reporting configuration information including information selected from the group of a frequency value for reporting to the audience measurement server, identification of the information to report, and identification of an audience measurement server.

Still further embodiment again includes generating, using a rights management server, a content protection signaling message and associating the content protection signaling message with a portion of a piece of content, where the content protection signaling message is an Entitlement Control Message (ECM) that is multiplexed with the portion of the piece of content in a transport stream and includes decryption information associated with the portion of the piece of content, and where the decryption information includes an encrypted control word (CW), generating a reference timestamp using the rights management server, embedding, using the rights management server, the reference timestamp within the content protection signaling message, receiving the portion of the piece of content using the playback device, where the piece of content is encrypted using at one encryption key, receiving the content protection signaling message using a playback device, processing the content protection signaling message using the playback device to extract the reference timestamp and the decryption information and generating a message processing timestamp based on the time the content protection signaling message is processed, determining a content identifier that identifies the piece of content using the playback device, collecting audience measurement data and saving the audience measurement data into memory, where the audience measurement data includes the reference timestamp, message processing timestamp, and content identifier, recovering at least one decryption key using the decryption information, decrypting the at least a portion of a piece of content using the at least one decryption key, and sending the audience measurement data to an audience measurement server using the playback device.

In still another embodiment again, a system for collecting audience measurement data using content protection signaling messages while playing back content includes a playback device including a processor, and memory including an audience measurement application, where the playback device processor is configured by the audience measurement application to receive a portion of a piece of content, where the piece of content is encrypted using at least one encryption key, receive a content protection signaling message, where the content protection signaling message is associated with the portion of the piece of content and includes a reference timestamp and decryption information associated with the portion of the piece of content, process the content protection signaling message to extract the reference timestamp and the decryption information and generate a message processing timestamp based on the time the content protection signaling message is processed, collect audience measurement data and save the audience measurement data into memory, where the audience measurement data includes the reference timestamp and message processing timestamp, recover at least one decryption key using the decryption information, decrypt the at least a portion of a piece of content using the at least one decryption key.

In a still further additional embodiment the system also includes a rights management server including a processor, and memory including a content protection application, where the rights management processor is configured by the content protection application to generate the content protection signaling message and associate the content protection signaling message with the portion of the piece of content, generate the reference timestamp, and embed the reference timestamp within the content protection signaling message.

In still another additional embodiment, the reference timestamp indicates the time of encryption of the portion of the piece of content associated with the content protection signaling message.

In a yet further embodiment again, the content protection signaling message is a modified Entitlement Control Message (ECM) that is multiplexed with the piece of content in a transport stream, the decryption information includes an encrypted control word (CW), and recovering at least one decryption key using the decryption information includes decrypting the encrypted control word (CW).

In yet another embodiment again, the content protection signaling message is a key delivery message provided in a playlist associated with the piece of content.

In a yet further additional embodiment, the playback device processor is also configured by the audience measurement application to determine a device identifier associated with the playback device using the playback device and an audience measurement server is configured by an audience measurement application to detect a compromised device using the device identifier.

In yet another additional embodiment, the playback device processor is also configured by the audience measurement application to determine a channel change event and the audience measurement data also includes the channel change event.

In a further additional embodiment again, the playback device processor is also configured by the audience measurement application to collect device information from the playback device, where device information includes information from the group of memory usage, network usage, error status, error event, device type, performance change event, and key delivery delay.

In another additional embodiment again, the playback device processor is also configured by the audience measurement application to determine a trick play event based upon at least the reference timestamp and a message processing time.

In a still yet further embodiment again, the playback device processor is also configured by the audience measurement application to receive a second content protection signaling message, where the second content protection signaling message is associated with the portion of the piece of content and includes a second reference timestamp, process the second content protection signaling message to extract the second reference timestamp and generate a second message processing timestamp based on the time the second content protection signaling message is processed, and determine a trick play speed using the reference timestamp, the second reference timestamp, the message processing time, and the second message processing time.

In still yet another embodiment again, the playback device processor is also configured by the audience measurement application to determine a content identifier that identifies the piece of content, and obtain a device identifier that identifies the playback device, where the audience measurement data also includes the content identifier and the device identifier.

In a still yet further additional embodiment, the playback device processor is also configured by the audience measurement application to obtain at least one encryption key from the rights management server, send the audience measurement data to an audience measurement server securely using the at least one key obtained from the rights management server.

In still yet another additional embodiment, the content protection signaling message also includes reporting configuration information including information selected from the group of a frequency value for reporting to the audience measurement server, identification of the information to report, and identification of an audience measurement server.

### BRIEF DESCRIPTION OF THE DRAWINGS

FIG. 1 is a block diagram showing a typical Conditional Access System (CAS) for content protection.

FIG. 2 is a system overview of a content playback system for collecting audience measurement data in accordance with embodiments of the invention.

FIG. 3A conceptually illustrates a rights management server in accordance with an embodiment of the invention.

FIG. 3B conceptually illustrates a playback device in accordance with an embodiment of the invention.

FIG. 3C conceptually illustrates an audience measurement server in accordance with an embodiment of the invention.

FIG. 4 provides an overview of an architecture showing a message flow of audience measurement data in accordance with an embodiment of the invention.

FIG. 5 is a flow chart illustrating a process for utilizing content protection signaling for audience measurement in accordance with an embodiment of the invention.

FIG. 6 is a block diagram showing an ECM packet layer structure in accordance with an embodiment of the invention.

FIG. 7 is a block diagram illustrating data retrieved by an AM-DMA process.

FIG. 8 illustrates a content protection signaling and AM-DMA Message Sequence Diagram in accordance with an embodiment of the invention.

FIG. 9 is a block diagram showing a fast forward (FF) speed calculation in accordance with an embodiment of the invention.

FIG. 10 is a block diagram showing an HLS DRM system and the flow of keys for encrypted video in accordance with an embodiment of the invention.

FIG. 11 is a sequence diagram showing HLS key flows and collecting mining data in accordance with an embodiment of the invention.

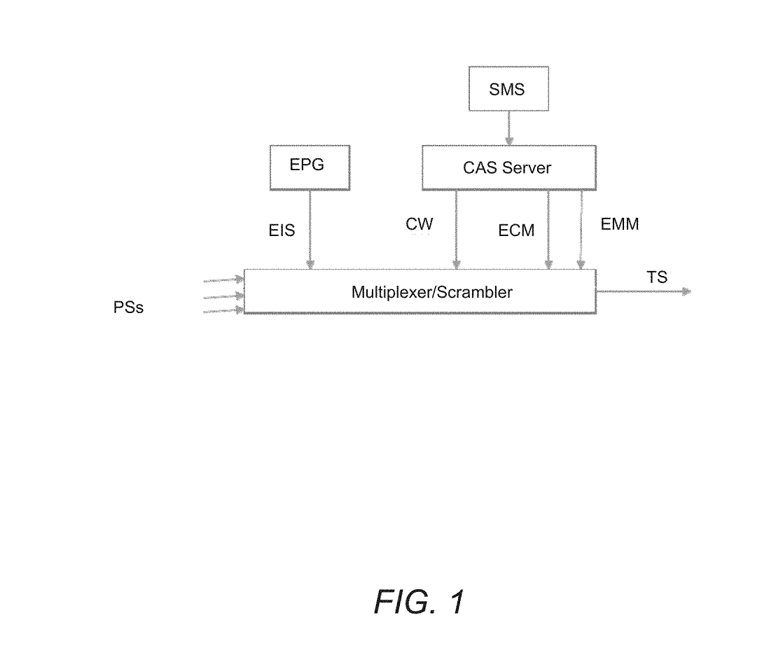

### DETAILED DISCLOSURE OF THE INVENTION

Systems and methods for utilizing content protection signaling to collect audience measurement data in accordance with embodiments of the invention are disclosed. Content protection signaling may refer to messages and/or other types of communication utilized in managing rights to play back digital content and/or facilitating the playback of content in accordance with granted rights. Some of these types of signaling can include Entitlement Control Messages (ECM) used in Conditional Access (CA) systems and key delivery messages used in adaptive bitrate streaming systems utilizing digital rights management (DRM) schemes. In many embodiments of the invention, a content protection signaling message includes at least an identifier for a piece of content and a reference timestamp.

Audience measurement data can include user viewing information such as, but not limited to, what content a user is watching, when the user is watching the content, what device the user is using to watch the content, how the user is watching the content (what type of content delivery) such as a live event or playing back of recorded content, and/or other types of information that could be considered “polling” data for assessing the viewership of particular pieces of content or viewing habits of users. In various embodiments of the invention, content protection signaling messages (such as ECMs) can be utilized to capture the digital trail of Big Data for operators to understand the user experience and quality experience in a way that can be used for cross/up sales, recommendations, targeted advertising and/or diagnostic messages for better customer experience and customer support. Use of content protection signaling messages in accordance with various embodiments of the invention allows for easy integration using an existing client security module to collect audience measurement data without middleware integration.

To enable the collection of a larger or complete subset of the population automatically in conventional systems, integration with several components is typically required. This integration can be slow, time consuming and costly. To enable integration with existing messaging, protocols and communication channels can facilitate the integration, deployment and use of the data. Many embodiments of the invention utilize and modify existing communication channels and modules that are used for DRM (Digital Rights Management) signalization and verification and enhance those with information that can be used for audience measurement. In one embodiment, the DRM in a Digital Television (DTV) often implemented as Conditional Access System (CA System) is collecting data using content protection signaling such as Entitlement Control Messages (ECM).

### System Architecture and Devices

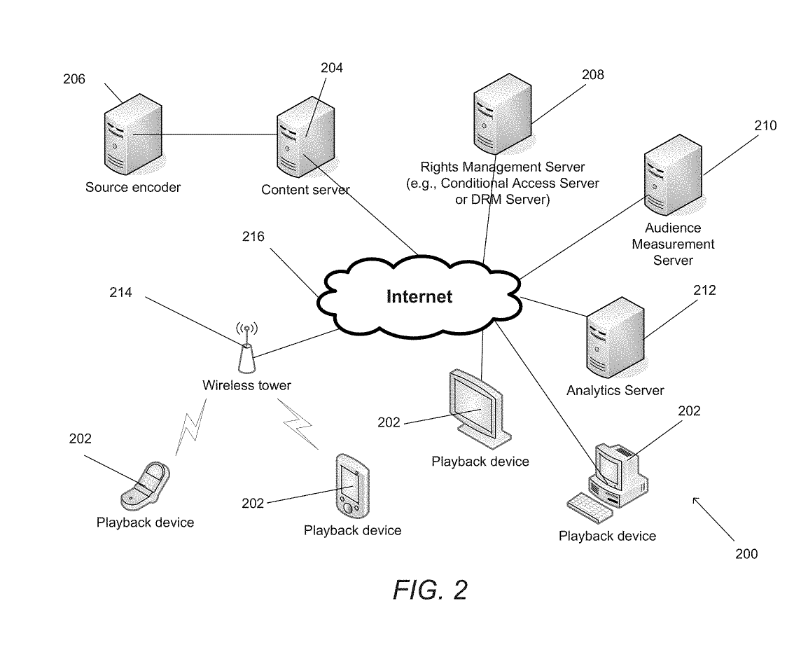

A content playback system for collecting audience measurement data in accordance with embodiments of the invention is illustrated in FIG. 2. The system 200 can include playback devices 202, a content server 204, a source encoder 206, a rights management server 208, an audience measurement server 210, and an analytics server 212 that communicate over a network 216 such as the Internet. Playback devices 202 can include personal computers, mobile phones, televisions, and/or other consumer devices such as set top boxes (STB) or tablets. Certain wireless playback devices may additionally communicate by wireless networks 214. Playback devices 202 may request content from the content server 204. Content server 204 can obtain encoded content from source encoder 206.

Playback devices 202 may receive content protection signaling messages from rights management server 208 when playing back content. As will be discussed further below, playback devices may collect audience measurement data using content protection signaling messages and save data into a log file. At least some of the data in a log file may be sent to an audience measurement server 210 and further communicated to an analytics server 212 for additional processing.

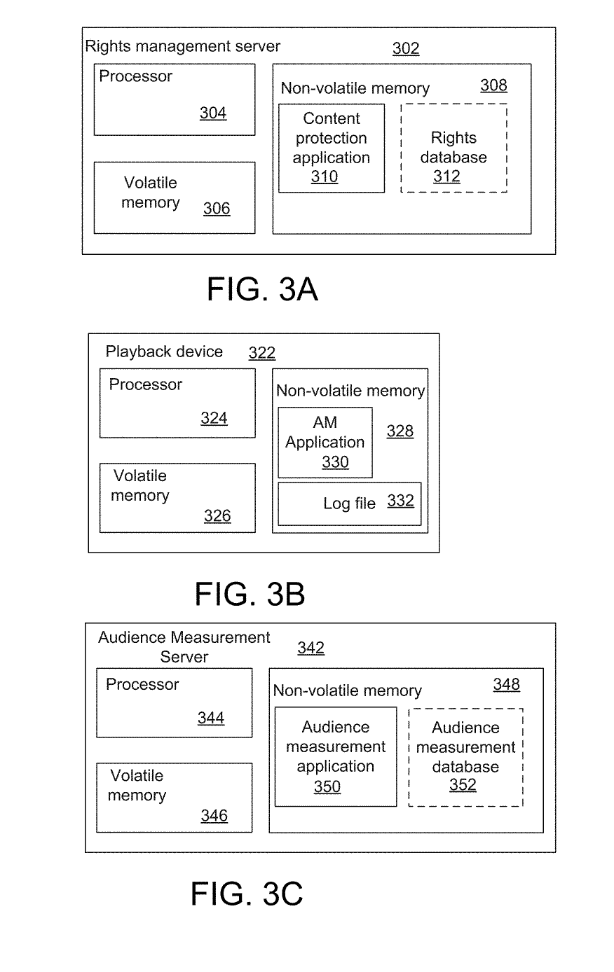

FIG. 3A conceptually illustrates a rights management server in accordance with an embodiment of the invention. The rights management server 302 includes a processor 304, volatile memory 306, and non-volatile memory 308. The non-volatile memory 308 includes a content protection application 310 that, when executed, configures the processor 304 to perform certain functions or processes such as processes for generating content protection signaling messages as will be discussed further below. The non-volatile memory 302 may also include a rights database 312 (or other appropriate data structure) that can store information concerning playback rights of various pieces of content that may be used in the generation of content protection signaling messages such as ECMs. A rights management server 302 provides the playback rights of content to playback devices using content protection signaling messages, such as by including decryption information in messages that enables a playback device to decrypt content. In various embodiments of the invention, a rights management server can be referred to using different terms corresponding to the type of protection system/scheme utilized in the content playback system such as, but not limited to, a CA server or DRM server.

FIG. 3B conceptually illustrates a playback device in accordance with embodiments of the invention. The playback device 322 includes a processor 324, volatile memory 326, and non-volatile memory 328. The non-volatile memory 328 includes an audience measurement application (AM-DMA) and optionally a log file 332 including audience measurement data. The AM-DMA, when executed, configures the processor 324 to perform certain functions or processes such as processes for collecting audience measurement data as will be discussed further below.

FIG. 3C conceptually illustrates an audience measurement server in accordance with embodiments of the invention. The audience measurement server 342 includes a processor 344, volatile memory 346, and non-volatile memory 348. The non-volatile memory 348 includes an audience measurement application that, when executed, configures the processor 344 to perform certain functions or processes such as processes for receiving audience measurement data from playback devices as will be discussed further below. The non-volatile memory 348 may also include an audience measurement database 352 that can be used to store audience measurement data received from playback devices.

In many embodiments of the invention, a client playback device is configured by an Audience Measurement-Data Mining Application (AM-DMA) to collect audience measurement data. In further embodiments, the AM-DMA configures the client playback device to deliver at least some of the collected audience measurement data over a network to a central location such as an Audience Measurement (AM) server. Audience Measurement Data can include specific types of data relating to user information: what content a user is watching on the device, when the user is watching the content on the device, what device the user is using, how the user is watching the content such as live or playing back recorded content or consuming video on demand (VOD). Playback devices can include computers or other consumer devices such as set top boxes (STB), tablets, mobile devices (such as smart phones), and televisions.

In several embodiments, the AM-DMA resides with DRM client software and can be controlled, updated and maintained with the DRM client software, allowing for a combined integration step. In this way, it may not require significant additional connections, APIs and device requirements.

While specific structures and capabilities of playback devices, rights management servers, and audience measurement servers are described above in accordance with embodiments of the invention, one skilled in the art will recognize that modifications or variations thereof may be implemented as appropriate to a particular application in accordance with embodiments of the invention.

### Processes for Audience Measurement Using Content Protection Signaling

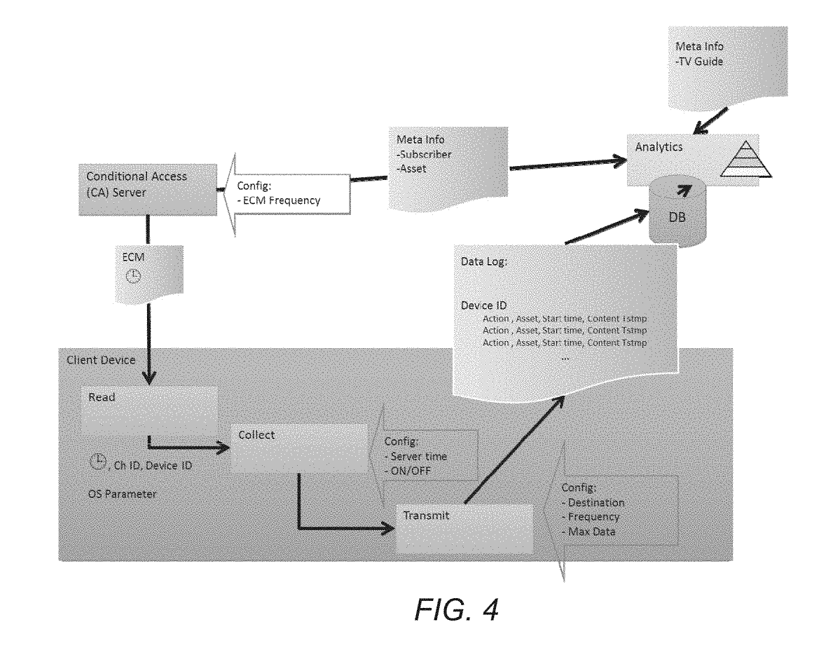

In many embodiments of the invention, a content playback system utilizes content protection signaling such as an Entitlement Control Message (ECM) to collect information about the behavior and experience of a consumer of video content. FIG. 4 conceptually illustrates an architecture diagram of a system utilizing ECMs for content protection signaling and audience measurement in accordance with an embodiment of the invention. It shows the message flow of ECM from the conditional access (CA) head end server to the client playback device. The CA server can be configured with parameters on the frequency of ECM delivery and the contents of each ECM.

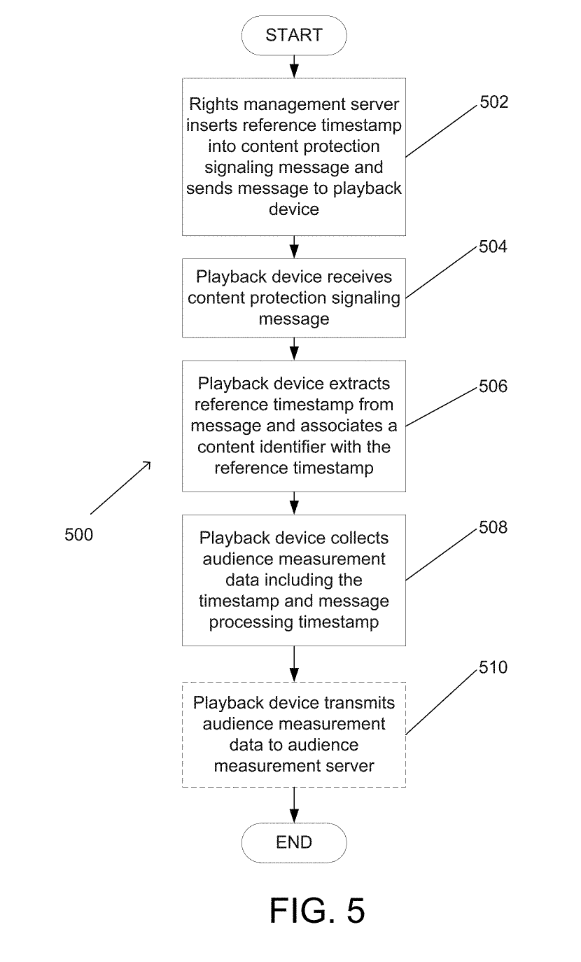

A process for utilizing content protection signaling for audience measurement in accordance with embodiments of the invention is illustrated in FIG. 5. The process 500 includes a rights management server sending 502 a content protection signaling message to a playback device. In some embodiments, the rights management server first generates the content protection signaling message.

In several embodiments, the rights management server is a CA server and the content protection signaling message is an ECM. As will be discussed further below, in other embodiments implementing adaptive bitrate streaming, the rights management server is a DRM server and the content protection signaling message is a key delivery message or other key management type message. In further embodiments of the invention, a content protection signaling message may be any of a variety of types of message that conveys viewing rights for a particular piece of content and/or decryption information that enables a device to decrypt at least a portion of a particular piece of content pursuant to viewing rights granted to a particular user. Decryption information may be pieces of information such as, but not limited to, one or more decryption keys, one or more control words (CW), an address for where to retrieve one or more decryption keys or control words (CW), other information enabling the retrieval or request of one or more decryption keys or control words (CW), and/or other information that enables decryption or access of the content.

An ECM, to function in a CA system, typically contains an identification of the channel, content, and/or video-on-demand (VOD) asset and information that is used to derive or retrieve a decryption key. The ECM may also contain other information that the CA client requires to secure the content. In several embodiments of the invention, a reference timestamp is added to use this communication channel, which is typically utilized for transmitting messages in regular intervals in order to secure the content, to enable collection of detailed information about consumer consumption behavior. A rights management server may thus embed or insert a reference timestamp into the content protection signaling message when generating the message and/or before sending the message to the playback device.

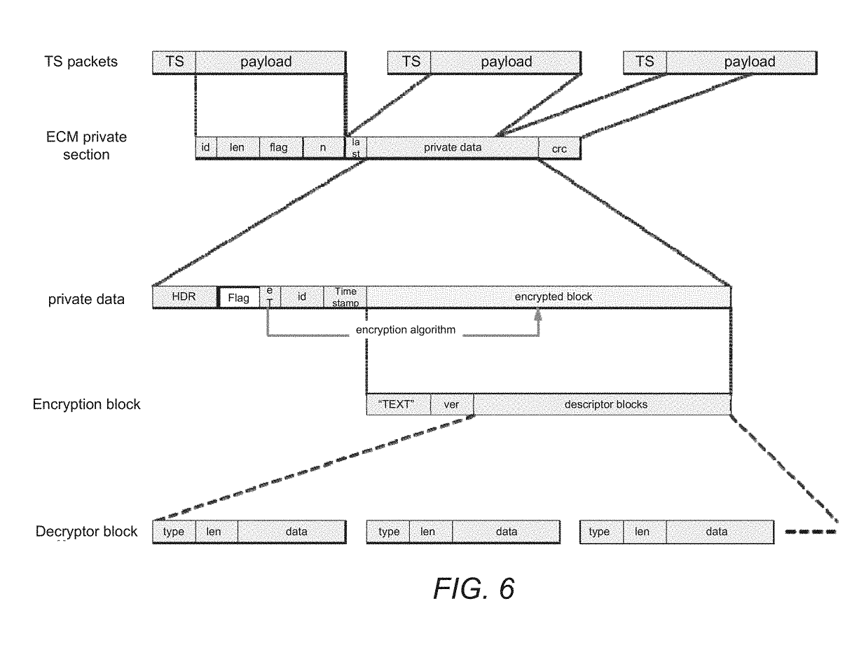

In several embodiments, the content protection signaling message is an ECM and the reference timestamp can be referred to as an ECM timestamp. FIG. 6 conceptually illustrates fields within a typical ECM and data blocks where a timestamp may be embedded in accordance with embodiments of the invention. In several embodiments, a timestamp is placed within a “data” block within a descriptor block, within an encryption block, within a “private data” block, within an ECM private section, where the ECM private section is broken up and carried as payload within transport stream (TS) blocks.

In many embodiments, a reference timestamp is intended to provide a chronologic reference point of the broadcast or transmission of a piece of content or individual portions of the piece of content. A reference timestamp may include both a date and time. Time may be specified in coordinated universal time (UTC), local time, or other format as appropriate to the application. In several embodiments of the invention, the reference timestamp in the content protection signaling message is the time of linear broadcasting (e.g., measured at the time of encryption) of the content or the portion of the content associated with or corresponding to the message. When each portion is transmitted at successively later times (i.e., in “real time”), the reference timestamps in content protection signaling messages corresponding to the portions may thus reflect successively later times. In some embodiments, the resolution (or frequency) of the timestamp is preferably chosen to derive channel change and trick-play with a sufficient resolution while the number should be large enough to cover the use of old content with minimum requirement for the size of this data, since it is transmitted frequently. A resolution of 1/10 or 1/100th of a second covering a several years may fit these guidelines. In various embodiments of the invention, the reference timestamp may be specified as the time of encryption of the content or portion of content corresponding to the content protection signaling message the timestamp is to embedded in, the time when the message is generated, the time the timestamp is embedded into the message, the time the content or portion of content is broadcast/transmitted, or other appropriate reference time. Any of the other times references as well as the time the message is received by a playback device may be inferred given one reference time and assumed or actual propagation delays.

In many embodiments, for VOD (video on demand) content the timestamps may start from 0 (i.e., relative time) and indicate the position within the asset. This also allows for re-use of the timestamp field and the small value of the timestamp in the VOD content can be indicative to distinguish VOD from linear content.

In other embodiments, the timestamp in VOD ECMs may represent the time the movie was released. By collecting the data of actual viewing, statistics about popularity of over time may be collected.

With VOD content that is downloaded for time-limited rental period or for purchase (e.g. electronic sell-thru or EST), the AM-DMA system may collect information about when the movie was download, when it was actually watched, how often, etc. Although particular reference times associated with timestamps are discussed above, one skilled in the art will recognize that embedded timestamps may be set to various reference times as appropriate to the particular application in accordance with embodiments of the invention.

In many embodiments of the invention, the content protection signaling message may contain additional information concerning the content such as a channel identifier (ID), content identifier (ID), asset identifier (ID), video on demand identifier (VOD ID), and/or other identifier. In several embodiments, the content protection signaling message includes reporting configuration information that can be used to configure the playback device in reporting audience measurement data to a remote server (such as, but not limited to, reference timestamps, content identifiers associated with timestamps, and/or trick playback). Reporting configuration information may include, but is not limited to, a frequency value for reporting to the audience measurement server, identification of the information to report, and/or identification of the audience measurement server.

The client device receives 504 the content protection signaling message (an ECM in several embodiments) and may store the message in memory. The device processes 506 the content protection signaling message to extract the timestamp embedded in the message as well as other optionally included information (such as, but not limited to, reporting configuration information and/or a channel or content identifier). The device may also determine additional information such as, but not limited to, information about the content delivered (such as by an extracted channel/content identifier or identifier the content by the transport stream that the content protection signaling message was embedded in), its current device time (from the device on-board clock or system clock) and device identifier (ID). The current device time can be saved as a message processing timestamp, which may be used in determining variations in playback such as trick play as will be discussed further below. In some embodiments, the content protection signaling message is processed during decryption, decoding, or playback of the content. Thus, when playing content that is streaming in real-time, processing of a content protection signaling message may occur when it is received, while when playing content that has been recorded at an earlier time the processing may occur at a later time.

In many embodiments, the client playback device receives portions of an encrypted piece of content. In further embodiments, the device receives content protection signaling messages that are associated with portions of the encrypted content, where the messages include decryption information for decrypting the corresponding portions of encrypted content.

Content protection signaling messages may be processed in the client playback device by an audience measurement application (AM-DMA). In several embodiments, the AM-DMA may be a component of a client conditional access (CA) or digital rights management (DRM) application. The timestamp embedded in the content protection signaling message may be read 506 together with the channel or asset ID (or VOD ID). In some embodiments, a channel identifier (ID), content identifier (ID), asset identifier (ID), or video on demand identifier (VOD ID), is embedded in the content protection signal and can be used to identify the channel or piece of content. In other embodiments, the content protection signaling message is multiplexed with the content or otherwise associated with the content such that the playback device can identify the content by its association, assign a content identifier, and associate the timestamp with the content identifier. The assigned content identifier can be reported with the reference timestamp as audience measurement data, such as in reporting to an audience measurement server as will be discussed further below.

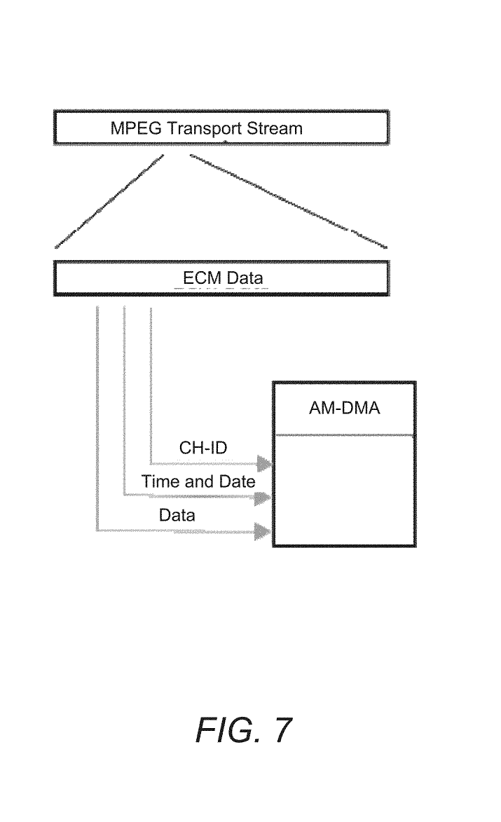

FIG. 7 is a block diagram conceptually illustrating some of the data retrieved by an AM-DMA process in accordance with several embodiments of the invention. An entitlement control message (ECM) from a MPEG transport stream (MPEG-TS: formally known as ISO/IEC standard 13818-1 or ITU-T Rec. H.222.0) contains channel (channel identifier [CH-ID] or other content identifier) and time (embedded timestamp) information and optionally other data pertinent to audience measurement as discussed further above, which can be extracted by the playback device configured by the AM-DMA. The AM-DMA may also collect information from the environment such as the current device time and device information, such as, but not limited to a device identifier and information concerning device capabilities. A device identifier (ID) can be based on any of a number of uniquely identifying numbers associated with a device, such as, but not limited to, a network MAC address, smartcard identification number, serial number of a chip, other assigned number, etc. A subscriber or user identifier (ID) may be used alternatively to or in combination with a device identifier (ID) to provide identifying information in audience measurement data. A subscriber or user identifier (ID) may be obtained from a content protection signaling message, from another type of message received by the playback device, from memory on the playback device, or via other means.

Additional information about the content may also be captured. For example, if multiple audio streams are multiplexed into the MPEG-TS, the AM-DMA may also report the specific language selected and used by the end-user. Where the content is available in different versions, such as different camera angles or in different quality levels (as in adaptive bitrate streaming, which is discussed further below), the version or alternative stream of the content that is being requested and/or played back by the device may be identified and saved as audience measurement data.

In some embodiments of the invention, all received ECMs may be forwarded to the CA module. In other embodiments, only one ECM is saved per crypto period (duration in the content that utilizes the same encryption key), ignoring the repeated redundant messages. Note that in some CA systems, all ECMs within the same crypto period may be identical. For the evaluation of the embedded timestamp, more ECMs are preferred but one per crypto period already provides useful data for many commonly used crypto period durations. The information is evaluated and collected. Collection may include removal of repetitive and redundant information and include device specific information such as information about the client environment or ID. Device identification may also be disabled and not collected if device identification is not enabled, e.g. for privacy reasons.

The AM-DMA can also capture device information that is indicative of characteristics, capabilities, performance, and/or resource capacity of the device, such as, but not limited to, CPU type, memory usage, network performance, error conditions, and/or security conditions such as delay in key delivery (reception of decryption keys). With this mining data to capture performance data, the operator can use the data to monitor and isolate problems quickly such as malfunctioning devices or network issues in certain areas.

In several embodiments of the invention, the playback device accesses received portions of encrypted content for playback using the decryption information. As discussed further above, the decryption information may include one or more decryption keys, which may be encrypted, and/or information about how to retrieve one or more decryption keys, such as an address from which to request keys. The playback device can decrypt the content using the one or more keys and play back the content.

In additional embodiments of the invention, a playback device configured by an AM-DMA may capture audience measurement data that includes events occurring on the playback device such as user-initiated events. Events may include changing channels (a channel change event) and trick play (fast forward or rewind, as will be discussed further below). Audience measurement data concerning an event may include an event start time that is determined based upon the time given by a system clock on the device when the event occurs, as well as characteristics of the event.

A secured CA or DRM system typically utilizes established communication protocols between the server and the client devices. Hackers often attempt to clone the client device or the client interface or otherwise defeat the protection system to access content without paying for a subscription or other access fee. Cloning may involve, for example, duplicating a device identifier or other identifying information about an authorized device and copying the identifier to another device that may not be authorized. The AM-DMA can provide mining information to verify if this is a correct client or is a cloned client attempting to access the network. For instance, if the AM server or the analytics server detects overlapping behavior associated with the same device (e.g. multiple devices with the same device ID requesting CA system access), it may flag it a suspicious behavior. Thus, the AM-DMA can be utilized as a means to perform clone detection of compromised devices for the CA system. Devices may be compromised by being cloned or having other vulnerabilities that may allow playback of content beyond the assigned rights.

The information that may include the channel/content/VOD identifier, reference timestamp, device identifier, user/subscriber identifier, message processing timestamp, and/or other information about the content or device as discussed above are collected as audience measurement data 508 on the device. The audience measurement data may be written into volatile or non-volatile memory. In several embodiments, audience measurement data is saved into one or more log files in non-volatile memory if collection is enabled and may be transmitted 510 in configurable intervals to an audience measurement server that can house a storage database for audience measurement data. In other embodiments, the audience measurement data remains in volatile memory and is transmitted 510 to an audience measurement server. For efficiency and/or scalability, portions of a log file may be sent at a time and a log file may not be sent in its entirety. An analytic server may access the storage database to process the data combining the metadata about the subscriber and asset information from the CA server.

The audience measurement server may be a local server, a cloud server, or a global data location shared by several operators. The frequency of the transmission may be configurable to meet an appropriate compromise between frequent updates that provide monitoring information closer to real time and less frequent updates that create less overhead. A mix can be used to create an early indication of lower resolution. Other traffic may be reduced to times with more available bandwidth. The transmission may also be triggered by the accumulation of a data amount beyond a predetermined threshold.

In additional embodiments, ECMs or other types of content protection signaling message may also carry information about how frequently data should be reported for the associated channel. For instance, live sports events such as the Super Bowl, may require information to be collected closer to real time. To this end, a frequency control value may be embedded in an ECM similar to embedding a timestamp.

In further embodiments, a client device may be instructed individually about its reporting frequency in key management messages (sometimes referred to as Entitlement Management Message [EMM] or Key Request message response). This can allow for targeted data collection for a specific group of people (e.g. based on demographics).

In still further embodiments, the audience measurement (AM) server may pull data from a specific client when needed. This can be viewed as a server pull mode compared to the push mode described further above.

In many embodiments utilizing a server pull mode, the transmitted audience measurement data is formatted in a log file that contains an identifier for a measured action on the client, an asset identifier, as well as a start time (duration until start time of next event) for this action and the content timestamp from the ECM. This example format provides an efficient storage in a database and evaluation by an analytics server. It is also simple enough to be possibly ingested in different analytics servers.

The analytics server can combine the data from the client devices with data from other devices of the same customer base or with data from other content distribution operators.

To enrich the data, the asset or channel ID can be matched with information about the content from sources such as a TV guide or data offerings from companies that provide this data. Such companies can include, but are not limited to, Tribune TV Data, Gemstar-TV Guide (now Rovi), FYI Television, Inc. in the United States and Europe, TV Media in the United States and Canada.

The analytics engine can also enrich the data with information stored in the operator head end that includes demographic information of the subscriber/user and information about the network and hardware operating conditions in the head end.

Collecting data about advertisement viewing can also be desirable. In many embodiments of the invention, a playback device configured by an AM-DMA can recognize behavior such as ‘pause’, ‘jump’, ‘skip’ and ‘FF’ during regular playback. The Analytics Server can match this pattern to additional metadata about advertisement insertion to collect information about advertisements viewed and those that were skipped. Additional indication of advertisement skipping can be short periods of channel changing during life viewing that can be matched by the analytics server to advertisement slots. Detecting trick play using AM-DMA processes is discussed in greater detail further below.

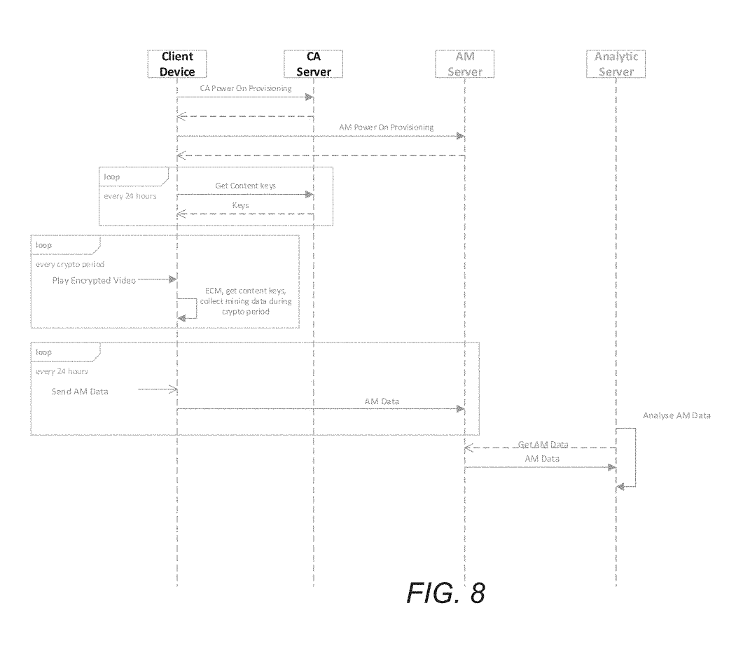

FIG. 8 illustrates a content protection signaling and AM-DMA Message Sequence Diagram in accordance with an embodiment of the invention. In the illustrated process, when a client playback device powered up, it establishes communications with a CA server and Audience Measurement (AM) server through secured provisioning. After the communication established, the client playback device requests content key information that is authorized for the user's paid subscription. In several embodiments, the “get all content key” request will typically repeat every 24 hours. When the client device receives encrypted video, an ECM packet from the content stream (MPEG transport stream [MPEG-TS]) will trigger the client device to look for the proper entitlement key to decrypt the content. In many embodiments, the ECMs are repeated using the same key, e.g. every 100 milliseconds. The duration in the content during which the same encryption key is used to encrypt portions of the content can be referred to as the crypto-period. Once the crypto-period (CP) expires (e.g. 10 seconds), subsequent ECMs will contain a different key. The CA client typically becomes involved and the contained Audience Measurement Data Mining Application (AM-DMA) is triggered and extracts the channel (or content) identifier, time information and optional additional control data. The obtained data is collected and securely stored in local storage. In many embodiments, the audience measurement data is securely transferred to an audience measurement (AM) server, which collects data at the head end. The CA or DRM system that authenticates the user and protects the content may also be used to authenticate and protect the data collected by the AM-DMA. The optional control data present in the ECM may indicate to the AM-DMA if additional data should be collected or when the collected data should be reported (i.e. overriding the default collection and reporting settings). This may be useful for special events or special channels where data needs to be collected faster to obtain more real-time measurements or slower to avoid network congestion.

The analytic server, which analyzes the audience measurement data, may access the Audience Measurement (AM) server storage database to process the data combining metadata about the subscriber/user and content/asset information from the CA server. By obtaining audience measurement data embedded in the content protection signaling, consumption behavior of subscribers can be monitored without requiring additional software modules or communication messages. In addition, using the content protection signaling messages, the AM-DMA can monitor quality of service parameters, such as network speed, network jitter, dropped packets/packages and bitrate of the content that the client playback device is currently using. In addition to the information derived from the signaling messages, the AM-DMA can monitor device and operating system parameters such as, but not limited to, CPU speed, CPU temperature, CPU usage, available memory, used memory, network performance. The analytics server can access and display the desired audience measurement data for analysis through any common network communication protocol. This provides the operator with a better understanding of the user behavior and their quality experience that can be used for cross/up sales, recommendations, targeted advertising and diagnostic messages for better customer support. Furthermore, determining actual advertisement viewing rate may be an important capability of the analytics engine.

Although a specific process for inserting reference timestamps into content protection signaling messages to collect audience measurement data is discussed above with respect to FIG. 5, one skilled in the art will recognize that any of a variety of processes and variations for collecting audience measurement data may be utilized in accordance with embodiments of the invention.

Additionally, the terms rights management server and CA server may be used interchangeably in the discussion above. Similarly, the terms content protection signaling message and ECM may be used interchangeably. One skilled in the art will recognize that a CA server is a type of rights management server and other types of rights management servers may be utilized in accordance with embodiments of the invention as appropriate to the particular application. Similarly, an ECM is a type of content protection signaling message and other types of content protection signaling messages may be utilized in accordance with embodiments of the invention.

### Trick Play as Audience Measurement Data

More and more people are using a DVR (digital video recorder) to record content. One of the benefits of using a DVR is the ability to skip commercials. These “trick play” features can include rewinding back 10 seconds for a second look, pausing a show to answer the phone, and fast forwarding to skip certain contents. The audience measurement data that captures the user consumption using these features e.g., with recorded content or VOD can provide valuable information for operators. From the content protection signaling messages, the trick play information can be derived as follows:

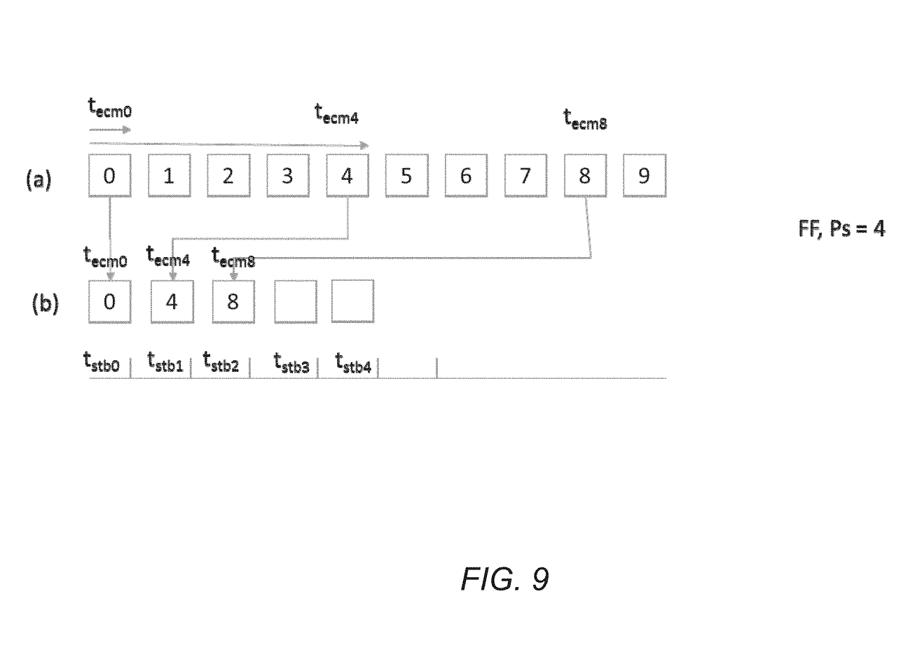

Let Ps be the play-back speed, then the normal play-back situation is can be defined as Ps=1. Two playback situations can be distinguished with respect to normal play. Fast playback is defined as Ps>1, whereas slow motion occurs for Ps<1 and Ps>0. FIG. 9 is a block diagram showing fast forward (FF) trick play via temporal sub-sampling where (a) is the normal play video sequence with pictures in sequence order and (b) is the fast forward video search trick play sequence with play back speed Ps=4 where only 1 in 4 frames is displayed. By using the ECM timestamp (t_{ecm}) and the client playback device current time reference (or message processing time) (t_{stb}), the playback device configured with the AM-DMA can determine whether the user is watching live content or recorded content and whether the user is doing fast forward or rewind at certain point of the content. Here we can refer to a set-top box (STB) as a playback device, although various playback devices can be utilized in accordance with embodiments of the invention as discussed further above.

The content can be inferred to be recorded if it was transmitted as linear (or real-time broadcast) content at some point (determined from an identifier in the signaling message) and the time in the ECM t_{ecm} is much older that the current time in the STB t_{stb}. Some delays may occur without recording due to transmission delay.

A special case of fast-forwarding is pausing and jumping/skipping allowed by some remote controls or user interfaces.

Another special case in between live viewing and playing back DVR content is pausing live content and resuming which eventually creates a delay where a user who initial started watching live content will slowly fall behind by several minutes.

For this comparison, it may be preferable that the time of the client playback device is synchronized with the server. Multiple mechanisms to accomplish this exist but often this synchronization is already provided by a CA/DRM system that synchronizes key expiration times with the server. This also includes compensation for different time zones, such that the ECM as well as STB time are using the same time zone.

To determine trick play, the relative differences between the ECM and the STB times can be measured. In several embodiments, when a signaling message is processed (typically upon playback), its embedded reference timestamp is recorded (t_{ecm}), along with the STB time, which is the current time in the receiving device (STB t_{stb}). Each saved STB time can then be seen as the message processing timestamp, or time that the associated ECM was processed.

Generally, if more time passes between ECM timestamps than STB timestamps, the ECM time moves faster and indicates speedup in the playback.

More specifically, the following equations are one method that ECMs with an added timestamp and device time can be used to determine trick play speeds.

FF if (t_{ecm}−t_{ecm-n}/(t_{stb}−t_{stb-n})>1+β

REW if (t_{ecm}−t_{ecm-n}/(t_{stb}−t_{stb-n})<−1−β

Playback speed=(t_{ecm}−t_{ecm-n}/(t_{stb}−t_{stb-n})

Pause if Playback speed=0 and

Slow motion when 0<Playback speed<1

Where β=jitter, t_{ecm}=current ECM time stamp, t_{ecm-n}=a previous ECM time stamp n ECMs earlier, t_{stb}=current STB time, t_{stb-n}=STB time when the ECM containing t_{ecm-n} was processed.

FIG. 9 is a block diagram showing an example fast forward (FF) speed calculation in accordance with embodiments of the invention. Using play speed Ps=4, the frames with the ECM timestamps t_{ecm0}, t_{ecm4}, t_{ecm8} are sent to the decoder to play at the current set top box (STB) time slots t_{stb0}, t_{stb1}, t_{stb2}. The play speed is (t_{ecm4}−t_{ecm0}/(t_{stb1}−t_{stb0}), (t_{ecm8}−t_{ecm4})/(t_{stb2}−t_{stb1}) and so on. The β=jitter is a constant that can be determined during setup, during provisioning/registration of the device, or during runtime in the client.

Jitter may be regarded as an undesired variation between ECM timestamps in packets that does not stem from user behavior and trick play. It can be used as a threshold to reduce the probability of wrongly detecting trick play when variations are not a desired effect triggered by the user.

Jitter may be introduced by factors such as different delay times for different portions of the content, irregular embedding of the ECMs in intervals that are not of equal duration or delay in processing the ECMs on the client playback device, e.g. due to temporal processing limitations on the client. Alternatively, tuning into a channel in the middle of a crypto period can also create a form of a jitter by processing the ECM not at the beginning of the crypto period but rather at the time of actually tuning into the channel.

Jitter can be measured, observed or estimated and used as a constant value in the equations discussed above. Alternatively it can be dynamically determined and adjusted for each client playback device by assuming that a playback interval with playback speed that is close to 1 is regular playback and measuring the differences in ECM packets during that time.

The value chosen for β can be seen as a compromise between decreasing the smallest trick play variation (small β) and a high probability of correct detection (large β).

With increasing values of n, the distance and time between two ECMs is increased but the precision can be seen as increasing, since jitter in each of the packets will be more likely to cancel out. The minimal detectable trick play duration will decrease but the likelihood of correction detection will increase. For increasing n, β is also increasing.

Some CA system may insert a sequence number in an ECM to facilitate the calculation of the timing, in particular if combined with a prior knowledge of the time between ECMs. The trick play speed can thus be calculated by using the difference of the two ECM sequence numbers.

An AM-DMA may also measure how long the user stays on a channel. If the duration falls below a configured threshold, it may indicate channel surfing/skipping and could be filtered out to increase relevance of collected data and minimize overhead.

Furthermore, an AM-DMA can collect information about user's attempts to tune to channels he/she is not authorized to view. Such information may be used by the operator to gauge interest in the channel, promote the channel by offering promotional free weekend of that channel, and eventually sell the channel subscription (or a related package) to the user.

Where an AM-DMA configures a playback device to capture audience measurement data concerning trick play or other features of playing back content, information about the event may be saved as audience measurement data such as the characteristics of the event (e.g., type and speed of trick play, channel changed from and to) as well as an event start time that is based on the time given by a system clock on the playback device when the event occurs. The concepts discussed above for collecting audience measurement data utilizing CA systems may be similar be applied to systems utilizing adaptive bit-rate streaming, which are be discussed below.

Audience Measurement with Adaptive Bit-Rate (ABR) Streaming

In additional embodiments of the invention, the same concept of combining data transmission and measurement with DRM relevant messages can be implemented with an AM-DMA in a secured conditional access system in other types of networks and data delivery methods that use message types other than EMCs, this can provide mining data across multiple networks with a consistent mechanism for measuring subscriber usage behavior data.

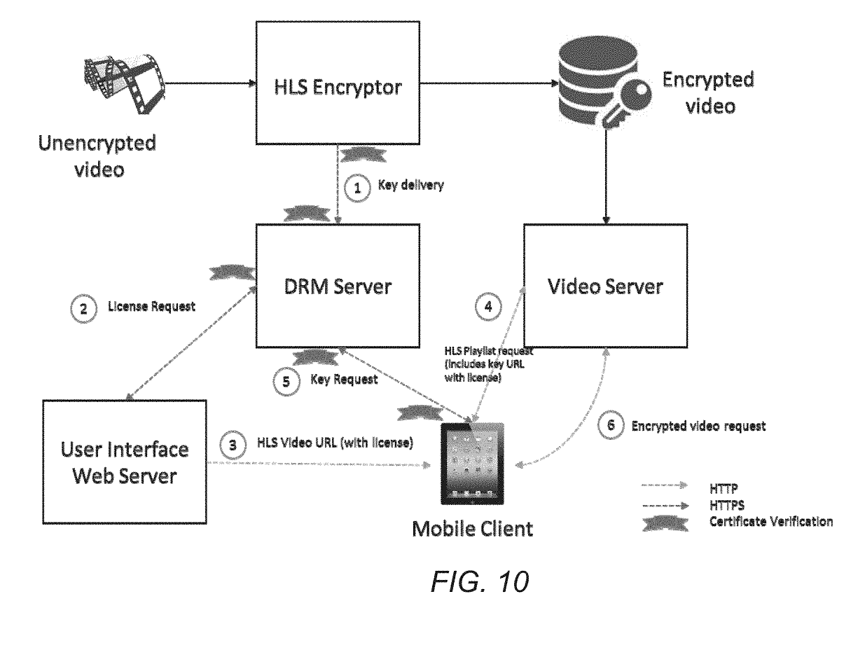

For video content delivered over unmanaged and unreliable network conditions, adaptive bitrate streaming methods like Apples HLS or DASH have become popular. Adaptive bitrate streaming is based on providing chunks of video typically in 2-10 seconds long segments. These segments are available from a content server in different resolutions. Segments are typically expressed by an HTTP URL in a manifest file and presented to the client playback device. After evaluating the available download bandwidth and/other other resources, the client playback device selects a stream/segment with the appropriate resolution and size (typically the highest quality available given the bandwidth and/other other resources) to download for playback. If available bandwidth decreases, a client playback device utilizing adaptive bitrate streaming will typically start downloading a lower quality or resolution version of the content by selecting a stream/segment at a lower quality or resolution. Adaptive bitrate streaming formats include, e.g., Apple's HTTP Live Streaming (HLS), Microsoft's Smooth Streaming, and Adobe's HTTP Dynamic Streaming and MPEG-DASH (dynamic adaptive streaming over HTTP) from the Motion Picture Expert Group (MPEG). These formats are based on the same fundamental principle of real-time adaptation of appropriate streams in unstable network conditions, but may differ in features such as file formats. The HLS protocol separates encryption (AES-128) and key distribution. In HLS the keys are fetched by the client from key URLs placed in the playlist files, providing information necessary to decrypt media files that follow it. Other adaptive streaming protocols have different triggers to fetch decryption keys but the concept and workflow remains similar. HLS is used in the example workflow below: FIG. 10 is a block diagram showing the HLS DRM and the flow of keys for encrypted video in accordance with an embodiment of the invention. The steps for each key used in the content are as follows:

1. The HLS Encryptor creates an encryption key, encrypts the video file with the key, and delivers the key securely to the DRM Server. In many embodiments, the key is a randomly generated AES-128 key. The encryption process happens once as the file is ingested into the system, but the file can be encrypted with multiple keys applied to different intervals within the content.

2. In response to a play request from a client playback device, a digital rights management (DRM) license (decryption key) is delivered to the client playback device. This may happen after the client has made its own checks for authorization to view the content and the user interface (‘middleware’) Web server requests a license for the client, for the requested asset, from the DRM Server. The DRM Server verifies the client certificate of the Web server before issuing the license.

3. The user interface Web server provides the HLS client with an HTTP URL to play the video with the license, adding the license as a ‘license’ parameter.

4. The HLS client requests the M3U playlist from the video server using the HTTP URL. The video server includes an EXT-X-KEY URL in the playlist which points back to the DRM Server, and also include the license as a parameter.

5. The HLS client requests the encryption key (in several embodiments an AES-128 key) for the content from the DRM Server, over HTTP Secure (HTTPS). The DRM server verifies the client certificate and also checks that the license quoted is valid for the client's IP address and has not expired. If all of the criteria are verified, the DRM server returns the key for the asset. In many embodiments, the process is performed with mutual certificate verification to prevent a man-in-the-middle attacker or a rogue client obtaining the key.

6. The key delivery message typically contains only the content decryption key. In many embodiments, the key delivery message functionality can be extended to contain additional information that aids in collecting data for audience measurement such as an embedded timestamp that is applied and used in ways similar to the ECM timestamp and/or the data collection control information described further above.

7. The client requests the encrypted video chunks from the video server. The HLS client can then decrypt the content and play it.

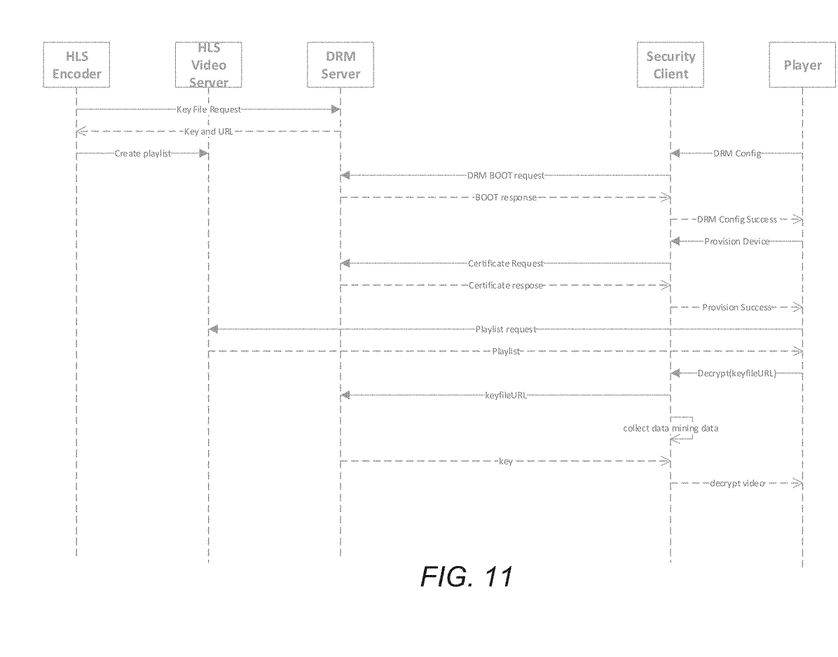

The AM-DMA can configure the client playback device to capture audience measurement information such as, but not limited to, the asset identifier, the embedded timestamp in the key delivery message, the current device time, the device type and/or the location where the video is being watched by the mobile client during or around the same time of the key request. FIG. 11 is a sequence diagram showing HLS key flows and collecting mining data in accordance with an embodiment of the invention.

Specifically, the data included in the key reply message may contain information such as, but not limited to, the time of original content creation (e.g. for VOD content) and/or the time of initial life streaming. As ABR content is typically sent individually to each client device (as opposed to broadcast or multicast used for traditional TV delivery), this information may help to create a statistical distribution of actual viewing patterns of this semi-live content.

An ABR system can also have an audience measurement server performing data logging by receiving audience measurement data. In various embodiments of the invention, an audience measurement server can be implemented as part of the CA (conditional Access) server or can be configured as a separate third party server component. The analytics server is typically not part of the CA system but has the capability to access the audience measurement/data logger server for analysis.

### Analytics and Processing for Collected Data

The content consumption data collected by systems and methods in accordance with embodiments of the invention enables use cases that allow a content distribution operator to improve their offering by, e.g.:

Offering addition content for sale that is found to be relevant for the targeted consumer because other consumers with a similar consumption profile liked that content.

Understanding the impact of quality on churn rate.

Understanding the relevance of each piece of content that is included in a subscription package and optimize the offering.

Ability to sell advertisement at a premium because of detailed measurement within an advertisement.

Ability to sell advertisement at a premium because of the ability to offer A/B testing in a large scale and to determine accurate results.

Ability to measure advertisement viewing rates.

Ability to understand viewer habits of watching on different types of devices, such as a mobile device vs. a home device.

Ability to understand what content type is more suitable for watching in different environments, such as at home on a large screen TV vs. personal viewing on a tablet vs. personal viewing on-the-go.

The disclosed embodiments are illustrative, not restrictive. While specific configurations of using ECM to do audience measurement data mining have been described, it is understood that the present invention can be applied to a wide variety of audience measurement data collection. Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

What is claimed is:

1. A method of collecting audience measurement data using content protection signaling messages while playing back content, the method comprising:
receiving a portion of a piece of content using a playback device, where the piece of content is encrypted using at least one encryption key;
receiving a content protection signaling message using the playback device, where the content protection signaling message is associated with the portion of the piece of content and comprises a reference timestamp and decryption information associated with the portion of the piece of content;
processing the content protection signaling message using the playback device to extract the reference timestamp and the decryption information and generating a message processing timestamp based on the time the content protection signaling message is processed;
collecting audience measurement data and saving the audience measurement data into memory, where the audience measurement data comprises the reference timestamp and message processing timestamp;
recovering at least one decryption key using the decryption information; and
decrypting the at least a portion of a piece of content using the at least one decryption key.

2. The method of claim 1 further comprising:
generating, using a rights management server, the content protection signaling message and associating the content protection signaling message with the portion of the piece of content;
generating the reference timestamp using the rights management server; and
embedding, using the rights management server, the reference timestamp within the content protection signaling message.

3. The method of claim 1 wherein the reference timestamp indicates the time of encryption of the portion of the piece of content associated with the content protection signaling message.

4. The method of claim 1, wherein the content protection signaling message is a modified Entitlement Control Message (ECM) that is multiplexed with the piece of content in a transport stream, the decryption information comprises an encrypted control word (CW), and recovering at least one decryption key using the decryption information comprises decrypting the encrypted control word (CW).

5. The method of claim 1, wherein the content protection signaling message is a key delivery message provided in a playlist associated with the piece of content.

6. The method of claim 1 further comprising determining a device identifier associated with the playback device using the playback device and detecting a compromised device using the device identifier.

7. The method of claim 1 further comprising determining a channel change event and the audience measurement data further comprises the channel change event.

8. The method of claim 1 further comprising collecting device information from the playback device, wherein device information comprises information from the group consisting of: memory usage, network usage, error status, error event, device type, performance change event, and key delivery delay.

9. The method of claim 1 further comprising:
determining a trick play event based upon at least the reference timestamp and a message processing time.

10. The method of claim 9 further comprising:
receiving a second content protection signaling message using the playback device, where the second content protection signaling message is associated with the portion of the piece of content and comprises a second reference timestamp;
processing the second content protection signaling message using the playback device to extract the second reference timestamp and generating a second message processing timestamp based on the time the second content protection signaling message is processed; and
determining a trick play speed using the reference timestamp, the second reference timestamp, the message processing time, and the second message processing time.

11. The method of claim 1 further comprising:
determining a content identifier that identifies the piece of content using the playback device; and
obtaining a device identifier that identifies the playback device using the playback device;
where the audience measurement data further comprises the content identifier and the device identifier.

12. The method of claim 1 further comprising:
obtaining at least one encryption key from the rights management server using the playback device; and
sending the audience measurement data to an audience measurement server securely using the playback device and the at least one key obtained from the rights management server.

13. The method of claim 1 wherein the content protection signaling message further comprises reporting configuration information comprising information selected from the group consisting of: a frequency value for reporting to the audience measurement server, identification of the information to report, and identification of an audience measurement server.

14. A method of collecting audience measurement data using content protection signaling messages while playing back content, the method comprising:
generating, using a rights management server, a content protection signaling message and associating the content protection signaling message with a portion of a piece of content, where the content protection signaling message is an Entitlement Control Message (ECM) that is multiplexed with the portion of the piece of content in a transport stream and comprises decryption information associated with the portion of the piece of content, and where the decryption information comprises an encrypted control word (CW);
generating a reference timestamp using the rights management server;
embedding, using the rights management server, the reference timestamp within the content protection signaling message;
receiving the portion of the piece of content using the playback device, where the piece of content is encrypted using at one encryption key;
receiving the content protection signaling message using a playback device;
processing the content protection signaling message using the playback device to extract the reference timestamp and the decryption information and generating a message processing timestamp based on the time the content protection signaling message is processed;
determining a content identifier that identifies the piece of content using the playback device;
collecting audience measurement data and saving the audience measurement data into memory, where the audience measurement data comprises the reference timestamp, message processing timestamp, and content identifier;
recovering at least one decryption key using the decryption information;
decrypting the at least a portion of a piece of content using the at least one decryption key; and
sending the audience measurement data to an audience measurement server using the playback device.

15. A system for collecting audience measurement data using content protection signaling messages while playing back content, the system comprising:
a playback device comprising:
a processor; and
memory comprising an audience measurement application;
wherein the playback device processor is configured by the audience measurement application to:
receive a portion of a piece of content, where the piece of content is encrypted using at least one encryption key;
receive a content protection signaling message, where the content protection signaling message is associated with the portion of the piece of content and comprises a reference timestamp and decryption information associated with the portion of the piece of content;
process the content protection signaling message to extract the reference timestamp and the decryption information and generate a message processing timestamp based on the time the content protection signaling message is processed;
collect audience measurement data and save the audience measurement data into memory, where the audience measurement data comprises the reference timestamp and message processing timestamp;
recover at least one decryption key using the decryption information; and
decrypt the at least a portion of a piece of content using the at least one decryption key.

16. The system of claim 15 further comprising:
a rights management server comprising:
a processor; and
memory comprising a content protection application;
where the rights management processor is configured by the content protection application to:
generate the content protection signaling message and associate the content protection signaling message with the portion of the piece of content;
generate the reference timestamp; and
embed the reference timestamp within the content protection signaling message.

17. The system of claim 15 wherein the reference timestamp indicates the time of encryption of the portion of the piece of content associated with the content protection signaling message.

18. The system of claim 15, wherein the content protection signaling message is a modified Entitlement Control Message (ECM) that is multiplexed with the piece of content in a transport stream, the decryption information comprises an encrypted control word (CW), and recovering at least one decryption key using the decryption information comprises decrypting the encrypted control word (CW).

19. The system of claim 15, wherein the content protection signaling message is a key delivery message provided in a playlist associated with the piece of content.

20. The system of claim 15 where the playback device processor is further configured by the audience measurement application to determine a device identifier associated with the playback device using the playback device and an audience measurement server is configured by an audience measurement application to detect a compromised device using the device identifier.

21. The system of claim 15 where the playback device processor is further configured by the audience measurement application to determine a channel change event and the audience measurement data further comprises the channel change event.

22. The system of claim 15 where the playback device processor is further configured by the audience measurement application to collect device information from the playback device, wherein device information comprises information from the group consisting of: memory usage, network usage, error status, error event, device type, performance change event, and key delivery delay.

23. The system of claim 15 where the playback device processor is further configured by the audience measurement application to:
determine a trick play event based upon at least the reference timestamp and a message processing time.

24. The system of claim 23 where the playback device processor is further configured by the audience measurement application to:
receive a second content protection signaling message, where the second content protection signaling message is associated with the portion of the piece of content and comprises a second reference timestamp;
process the second content protection signaling message to extract the second reference timestamp and generate a second message processing timestamp based on the time the second content protection signaling message is processed; and
determine a trick play speed using the reference timestamp, the second reference timestamp, the message processing time, and the second message processing time.

25. The system of claim 15 where the playback device processor is further configured by the audience measurement application to:
determine a content identifier that identifies the piece of content; and
obtain a device identifier that identifies the playback device;
where the audience measurement data further comprises the content identifier and the device identifier.

26. The system of claim 15 where the playback device processor is further configured by the audience measurement application to:
obtain at least one encryption key from the rights management server; and
send the audience measurement data to an audience measurement server securely using the at least one key obtained from the rights management server.

27. The system of claim 25 wherein the content protection signaling message further comprises reporting configuration information comprising information selected from the group consisting of: a frequency value for reporting to the audience measurement server, identification of the information to report, and identification of an audience measurement server.
